(19) United States
(12) Patent Application Publication
(10) Pub. No.: US 2023/0130691 A1
(43) Pub. Date: Apr. 27, 2023

(54) BAFFLE STRAINER SYSTEM AND METHOD

(71) Applicant: Treau, Inc., San Francisco, CA (US)

(72) Inventors: Shail Shah, Oakland, CA (US); Grace Li, San Francisco, CA (US); Wendy Trattner, San Francisco, CA (US); Santhi Analytis, Berkeley, CA (US); Steve Gennrich, San Francisco, CA (US); Jason Stein Wexler, San Francisco, CA (US); Kipp Bradford, Pawtucket, RI (US); Vincent Domenic Romanin, San Francisco, CA (US)

(21) Appl. No.: 17/970,915

(22) Filed: Oct. 21, 2022

Related U.S. Application Data
(60) Provisional application No. 63/270,197, filed on Oct. 21, 2021.

(51) Int. Cl. F24F 1/032; F24F 1/027; F24F 1/031; F24F 1/0018

(52) U.S. Cl. CPC F24F 1/032; F24F 1/027; F24F 1/031; F24F 1/0018

(57) ABSTRACT

An air conditioning unit comprising a baffle strainer tank that includes: a tank body defining a tank cavity, a liquid intake that defines a liquid intake port, a liquid outlet that defines a liquid outlet port, and a baffle strainer assembly.

### CROSS-REFERENCE TO RELATED APPLICATIONS

This application is a non-provisional of and claims the benefit of U.S. Provisional Application No. 63/270,197, filed Oct. 21, 2021, entitled “BAFFLE STRAINER SYSTEM AND METHOD FOR HYDRONIC LOOP FILTRATION AND AIR ENTRAINMENT REDUCTION,” with attorney docket number 0111058-008PRO. This application is hereby incorporated herein by reference in its entirety and for all purposes.

This application is also related to U.S. patent application Ser. No. 17/017,066, filed Sep. 10, 2020, entitled “WINDOW INSTALLATION SYSTEM AND METHOD FOR SPLIT-ARCHITECTURE AIR CONDITIONING UNIT,” with attorney docket number 0111058-003US0. This application is hereby incorporated herein by reference in its entirety and for all purposes.

This application is also related to U.S. patent application Ser. No. 12/724,036, filed Mar. 15, 2010, entitled “MODULAR AIR CONDITIONING SYSTEM,” with attorney docket number 0111058-004US0. This application is hereby incorporated herein by reference in its entirety and for all purposes.

### BACKGROUND

In 1931, H. H. Schultz and J. Q. Sherman invented the first room air conditioner. The unit sat on the ledge of a window, just as many modern air conditioners do. They were not widely purchased, however, due to their high cost at the time. It was not until the 1970s that window AC units made it into most homes in the United States, with over one million units sold in just 1953. Residential air conditioning has progressed a long way in the past several decades in terms of noise, efficiency, and cost. However, some features have remained unchanged, namely the installation process. Traditional room air conditioning units still sit on window ledges and are mounted in the sash of double-hung windows. The units usually require the user to screw in the unit, accordion panels, and/or an additional external bracket for support. During the installation process, users often have to precariously balance the air conditioning unit between the window sill and the window pane while securing the system, which leads to units falling outside if the user accidentally loses his or her grip.

An alternative to window air conditioning units are ductless systems comprised of at least two units, one outdoor unit and one indoor unit. These systems either contain a singular indoor unit coupled with a singular outdoor unit and are referred to as mini-splits, or several indoor units coupled with a singular outdoor unit and are referred to as multi-splits. Ductless systems do not need a duct to carry cooled or warmed air as central or packaged systems do, but they still use ducts to contain the coolant fluid carrying heat in and out of the room. These systems must be installed through a wall by a professional HVAC technician. The professional installation process is typically expensive and time-consuming. The installed cost of a high-performance mini-split air conditioner for a single room can be more than 10 times that of a window unit capable of cooling the same space. However, the advantage of ductless systems is that they allow for much higher efficiency than window air conditioning units and are often much quieter.

With demand for air conditioners continuing to grow, decreasing the cost and increasing the convenience of installing high-efficiency HVAC systems would help to remove barriers to adoption. In addition, a safer and more user-friendly installation process would remove the dangers associated with configuring current air conditioning units.

Air and debris management can be desirable in various types of fluid pump systems. In some examples of an HVAC hydronic loop, air entrainment in the working fluid can drastically decrease system efficiency by altering the fluid's heat transfer properties and increasing flow resistance. The presence and repeated implosion of bubbles can also cause damage to the system's pump over time in various examples. Likewise, it can be desirable in some examples to minimize debris in the system, such as dust and other small particles, which can enter when the system is initially assembled or opened for maintenance. Debris can reduce the system efficiency, cause blockages, and damage system components.

Current methods to reduce air entrainment in hydronic systems include various mechanisms and design strategies. Larger boiler systems with hydronic loops often include air eliminators or air separators, mechanical devices that capture and release air bubbles from the system. Other fluid tank systems use baffles to disrupt fluid flow and encourage larger bubble formation, since these are more easily released from the system. For example, aquariums sometimes use a sponge filter baffle to dissipate bubbles from their pump filtration system. Other tanks use built-in baffles which are designed as part of the tank, and therefore cannot easily be removed or changed.

The most common methods to reduce debris in hydronic closed-loop systems include bag filters, cartridge filters, sand filters, and other types of inline strainers. Commercially available filters for small closed-loop systems tend to be large, heavy, and expensive, and are not suitable for small consumer products. These are often a necessary component of a fluid loop, such that removing them will break the loop. Replacement may require tools, and can be difficult or messy. Further, the limited surface area of these filters requires that the filter be replaced frequently, as trapped debris starts to reduce fluid flow through the system.

In view of the foregoing, a need exists for an improved baffle and strainer system and method for small hydronic loop filtration and air entrainment reduction in an effort to overcome the aforementioned obstacles and deficiencies of conventional filtration and air entrainment reduction systems.

### BRIEF DESCRIPTION OF THE DRAWINGS

FIG. 1 illustrates a split-architecture air conditioning unit in accordance with one example embodiment.

FIG. 2 illustrates a split-architecture air conditioning unit disposed within a window in accordance with one example embodiment.

FIG. 3a illustrates a modular climate control unit in accordance with one example embodiment.

FIG. 3b illustrates a circulation hose in accordance with one example embodiment.

FIG. 4 illustrates an external unit comprising a heat pump/air conditioning cycle in accordance with one example embodiment.

FIG. 5 illustrates circulating fluid directed to reduce the overall temperature of a fluid storage tank within the interior unit in accordance with one example embodiment.

FIG. 6 illustrates an example embodiment of a modular climate control unit with three example locations of where a baffle strainer tank can be located in various examples.

FIG. 7 illustrates one example embodiment of a baffle strainer tank that comprises a tank body defining an internal tank cavity.

FIG. 8 illustrates another example embodiment of a baffle strainer tank that comprises a baffle that extends from a cap shaft and/or cap into a first cavity portion of a tank cavity and over at least a portion of a liquid intake port.

FIG. 9 illustrates a further embodiment of a baffle strainer tank in a disassembled configuration that includes a baffle strainer assembly comprising a baffle configured to be disposed within a strainer tube via an opening of the strainer tube.

FIG. 10 illustrates elements of a baffle strainer assembly including a strainer tube having a cylindrical strainer that extends between a first and second end and a baffle comprising an elongated baffle shaft with a baffle base disposed at the first end and baffle plug disposed at the second end of the baffle shaft.

FIG. 11 illustrates an embodiment of an assembled baffle strainer assembly where the length of the baffle shaft is configured such that the first end of the baffle is disposed within the strainer cavity set back from the first end of the strainer tube and set back from a strainer cuff at the first end of the strainer tube.

FIG. 12 illustrates another embodiment of a baffle where the first end of the baffle shaft comprises a platform assembly that includes a plurality of legs extending laterally and downward from a baffle base to a base ring.

FIG. 13 illustrates another example embodiment of a baffle strainer tank that includes a baffle strainer assembly comprising a baffle and strainer tube with the bottom end of the strainer tube disposed within a coupling slot defined by the tank body.

FIG. 14a illustrates an example embodiment where a gasket is disposed between the first end of a baffle strainer assembly and a tank body within a coupling slot proximate to a liquid intake.

FIG. 14b illustrates another example embodiment comprising a spring-plate assembly.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

The description below discloses various embodiments of a novel installation system and method for installing a split-architecture air conditioning unit through a window. As discussed herein, the term air conditioning unit can apply to a unit configured to condition air in various suitable ways including one or more of heating, cooling, moving air with a fan, de-humidifying, humidifying, filtering, and the like.

The systems and methods described herein, in some examples, allow for the installation of an air conditioner/heat pump with split-architecture through a standard window opening with no specialized tools (removing the need of a professional HVAC technician), no modification of the building envelope, and preventing the possibility of the unit accidentally falling out of the window during installation.

Various embodiments can include an air conditioning unit installation that can comprise, consist of, or consist essentially of an outdoor unit, an indoor unit, a bracket assembly configured to facilitate installation and holding of the outdoor and indoor units on opposing sides of the sill of a window, and an operable coupling between the outdoor unit and indoor unit that provides for operation of the air conditioning unit (e.g., one or more fluid lines, power lines, communication lines, and the like). As discussed herein, one or more of such elements can be modular.

Various embodiments can minimize the number of steps required for installation of elements of the air conditioning unit, can reduce user error during installation of the air conditioning unit, and the like. For example, some embodiments include a weight offset mechanism that is directly incorporated into the bracket.

Various embodiments can provide for a smooth transition of the outdoor unit to a final position outside of the window including preventing the outdoor unit from falling out the window and providing for easy manipulation of the outdoor unit when initially engaging the outdoor unit with the bracket, and moving the outdoor unit through the window and rotating the outdoor unit from a horizontal installation orientation to a vertical installed orientation. For example, as discussed in more detail herein, some embodiments can include flanges on the sides of the bracket that help guide the user in safely pushing the unit out of the window. Additionally, various embodiments can be configured to be adapted to a variety of windows or openings.

Additionally, various embodiments can be configured to be adapted to a variety of windows in terms of size and shape, including width of the window, thickness of the window sill, distance between an internal wall face and an external wall face, height of the window sill from the floor of an indoor area, and the like.

The system, in some embodiments, allows for the combination of a baffle and strainer system to both reduce air entrainment and to filter debris so that the two parts may fit together and act as a single part. In another embodiment, the suction strainer and baffle can be separate, modular components that are inserted into a tank.

The system can take several different forms that can allow it to both filter and remove air from a closed hydronic loop. A preferred embodiment includes a cylindrical strainer and a baffle which may be inserted into the strainer. The top of the baffle may seal one end of the strainer, while the other end acts as an entrance for the hydronic loop fluid.

The strainer may take several forms. A preferred embodiment of the strainer can include a 2-layer mesh comprising, consisting essentially of, or consisting of a fine mesh filter cylinder surrounded by a coarser mesh cylinder which provides structural support. The cylinder may be open on both ends or sealed on one end. In another embodiment, the strainer may be a rectangular screen through which fluid must flow from the inlet to the outlet.

The baffle can take several forms. A preferred embodiment of the baffle includes a long neck, which may have various shapes, and a flat circular structure on its end, which may take various other shapes. The flat surface at the end of the baffle can be offset from the inlet of the tank in some examples to slow down the flow of the incoming fluid. The baffle may be placed in the center of the strainer and extend along the axial length of the strainer. The flat baffle end structure can be centered or concentric with the strainer, but with a smaller diameter, such that fluid passing through the strainer will be disrupted but able to flow through the entire strainer length.

The strainer and baffle may be designed to be inserted into the fluid system as a modular piece, such that it can be easily inserted and removed from the fluid loop without disrupting the function of the fluid loop. Because the strainer and baffle are both separate from the fluid loop in various embodiments, a baffle or strainer design change may not require the fluid loop system to change. The baffle and strainer in some examples may be inserted and removed directly through a simple opening, such as a cap on the expansion tank. This can allow for simple filter replacement. In some examples, the system can be sealed and held in place by axial pressure from another component such as a threaded cap. In some examples, the baffle strainer system includes compliant polymer gaskets on each end of the strainer which improve the system's ability to seal itself with axial force.

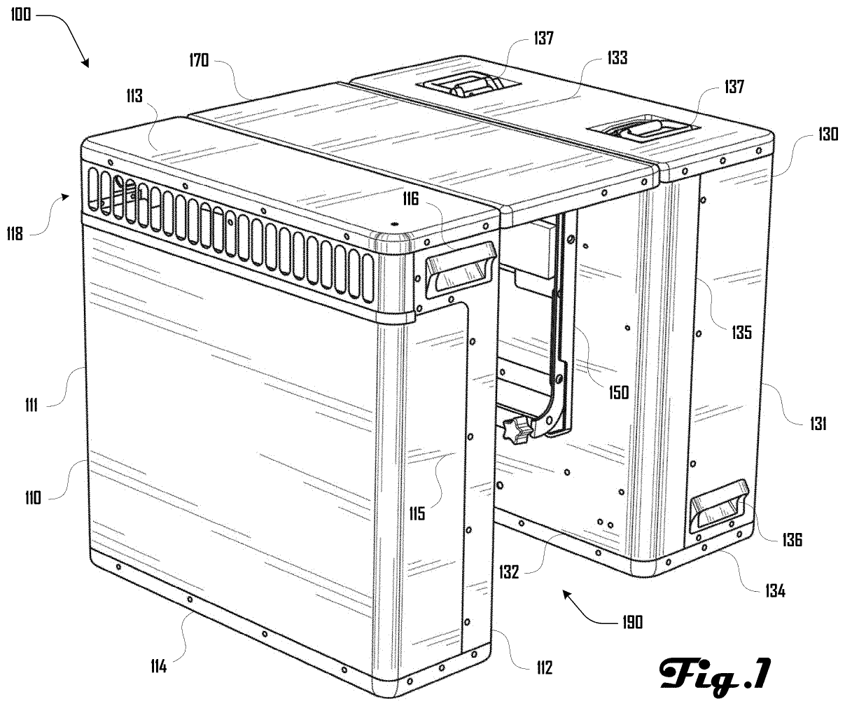

Turning to FIG. 1, an example embodiment of an air conditioning unit 100 is illustrated, which can comprise an indoor unit 110, an outdoor unit 130, a bracket assembly 150 and top cover 170, which can define an air conditioning unit cavity 190 between the indoor and outdoor units 110, 130 and below the top cover 170. The air conditioning unit 100 can further comprise an operable coupling (not shown) between the outdoor unit 130 and indoor unit 110, such as below or within the top cover 170, that provides for operation of the air conditioning unit 100, which can include one or more fluid lines, power lines, communication lines, and the like.

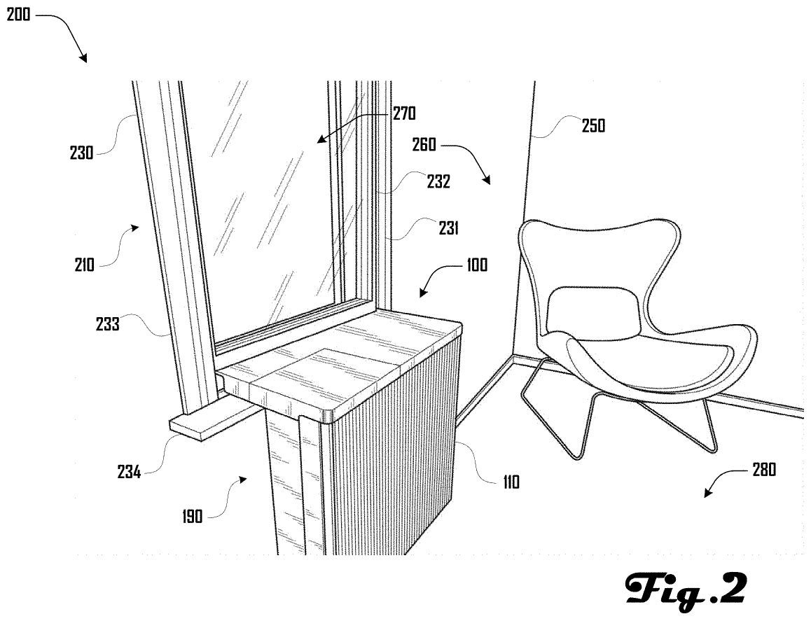

As discussed in more detail herein (see e.g., FIG. 2), in various embodiments, the bracket assembly 150 can be configured to couple with the sill of a window with the wall below the window sill being disposed within the cavity 190 such that the indoor unit 110 is disposed within an indoor space proximate to the window; the outdoor unit 130 is disposed in an outdoor space proximate to the window; and with the top cover 170 and operable coupling extending through the window and over the sill of the window.

As shown in the example of FIG. 1, the internal unit 110 can be generally cuboid and define a front face 111, internal face 112, top face 113, bottom face 114 and side faces 115. A pair of internal unit handles 116 can be disposed on the opposing side faces 115 proximate to the top face 113 of the internal unit 110. The internal unit handles 116 can be used for lifting the internal unit during installation of the internal unit 110 as discussed in more detail herein. A grille 118 can be defined by a portion of the front face 111, which can provide a passage from inside the internal unit 110 through which conditioned air can be expelled into an internal environment and/or air can be taken in from the internal environment as discussed in more detail herein.

The external unit 130 can be generally cuboid and define a front face 131, internal face 132, top face 133, bottom face 134 and side faces 135. A pair of external unit side-handles 136 can be disposed on the opposing side faces 135 proximate to the bottom face 134 of the external unit 130. The external unit side-handles 136 can be used for lifting the external unit 130. During installation of the external unit 130 as discussed in more detail herein. One or more external unit top-handles 137 can be disposed on the top face 133 of the external unit 130 and can be used for lifting and manipulating the external unit 130 during installation of the external unit 130 as discussed in more detail herein. The external unit 130 can further include one or more grille, port or other suitable structure(s) (not shown), which can provide a passage from inside the external unit 130 through which conditioned air can be expelled into an external environment and/or air can be taken in from an external environment as discussed in more detail herein.

Turning to FIG. 2, an example building 200 is shown that includes a wall assembly 210 with a window 230 disposed within a wall 250, which separates an internal environment 260 within the building 200 (e.g., a room) from an external environment 270 that is external to the building 200 (e.g., an outdoor area). The example window 230 comprises a sash 231 and pane 232 that moveably reside within a frame 233 that includes a sill 234. The sash 231 can be configured to raise and lower within the frame 233, and when open, define an opening between the internal and external environments 260, 270.

An example air conditioning unit 100 is shown disposed extending through the window 230 with the internal unit 110 disposed within the internal environment 260 and the external unit 130 disposed in the external environment 270. The internal and external units 110, 130 extend below the sill 234 toward a floor 280 of the building 200 with a portion of the wall 250 below the sill 234 disposed within the cavity 190 of the air conditioning unit 100. As discussed herein, the air conditioning unit 100 can be used to condition air in the internal and/or external environments 260, 270. For example, in various embodiments, the air conditioning unit 100 can be configured to cool the internal environment 260. In various embodiments, the air conditioning unit 100 can be configured to heat the internal environment 260.

While some embodiments are configured for residential use of an air conditioning unit within windows 230 of a home, it should be clear that an air conditioning unit 100 of further embodiments can be used in various other suitable ways, including in commercial settings such as in an office, factory, laboratory, school, vehicle, or the like. Also, the terms internal and external should not be construed to be limiting and are merely intended to represent separate environments, which can be partially or completely separated in various suitable ways, including by structures such as walls, windows, doors, screens, shades, partitions, sheets, and the like. Additionally, while various examples can relate to air conditioners disposed within a window 230, it should be clear that further examples can be disposed in any suitable opening between internal and external environments, such as a door, slot, flue, vent, skylight, drain, or the like. Accordingly, the specific examples discussed herein should not be construed to be limiting on the wide variety of air conditioning units that are within the scope and spirit of the present disclosure.

In various embodiments, an air conditioning unit 100 can be modular with the internal and external units 110, 130 configured to be separated from the bracket assembly 150. Such embodiments can be desirable in some examples because having such elements separate can make installation of the air conditioner unit 100 easier compared to an air conditioning unit 100 that is a unitary structure.

In various embodiments, the bracket assembly 150 can be configured to facilitate installation of the internal and external units 110, 130, including facilitating moving the external unit 130 through an opening (e.g., a window 230) and positioning the external unit in an external environment 270 proximate to the opening.

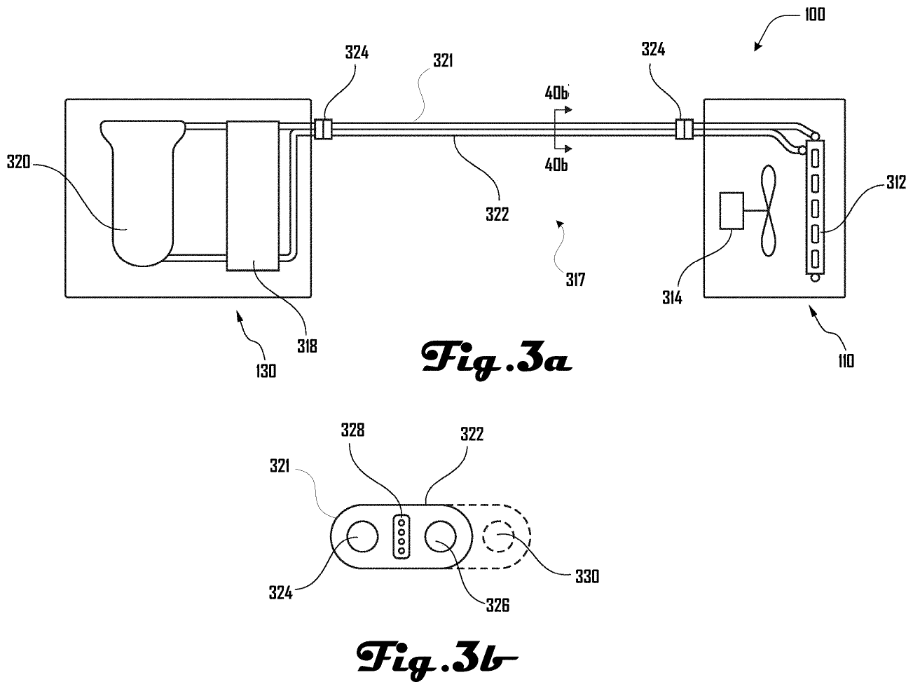

Turning to FIGS. 3a, 3b, 4 and 5, an example embodiment of a modular climate control unit 100 is illustrated. As shown in FIG. 3a, the modular climate control unit 100 can include at least one user-positionable interior unit 110 wherein the interior unit 110 includes a fluid-to-air heat exchanger 312 and a fan 314 to circulate air across the fluid-to-air heat exchanger 312, an exterior unit 130 including a fluid-to-fluid heat exchanger 318 and a system 320 for supplying a working fluid having a controlled temperature to a first side of the fluid-to-fluid heat exchanger 318 and a circulation hose 322 defining one or more operable connections 321 between a fluid side of the fluid-to-air heat exchanger 312 and a second side of the fluid-to-fluid heat exchanger 318, wherein the circulation hose 322 allows a circulating fluid to transport heat between the at least one interior unit 110 and the exterior unit 130. As will be discussed in more detail below, the circulating fluid can be a non-toxic, user serviceable fluid and the circulation hose 322 can be coupled to at least one interior unit 110 and the exterior unit 130 in a releasable manner.

Turning to the example exterior unit 130 in more detail, the exterior unit 130 can comprise a system 320 for controlling the temperature of a working fluid. The system 320 for controlling the temperature may be a heat pump, compressor or the like. In the case of a heat pump, the system 320 may provide, add or remove heat to/from the working fluid. In contrast, if only a compressor is provided, the system 320 may remove heat from the working fluid. Further, the exterior unit 130 can include a fluid-to-fluid heat exchanger 318 that can allow the exchange of heat between the working fluid on one side of the heat exchanger 318 and the circulating fluid on the other side of the heat exchanger 318. A fan and various other components such as controls may also be included in the exterior unit 130 in some embodiments.

The interior unit 110 can comprise a fan 314 and a fluid-to-air heat exchanger 312. In some examples, the interior unit 110 includes a fluid pump and a circulating fluid storage tank that will operate as described below in more detail.

The circulation hose 322 can comprise a detachable hose that extends between the interior unit 110 and exterior unit 130. For example, as can be seen at FIG. 3b, the circulation hose 322 can include three lumens therein that act as a fluid supply 324, a fluid return 326 and wiring 328 for power and/or control signals between the interior unit 110 and exterior unit 130. The circulation hose 322 may further optionally include a fourth lumen 330 to serve as a conduit to convey condensate back to the exterior unit 130 from the interior unit 110 preventing the need for a condensate drain therein.

It can be appreciated by one skilled in the art that within the scope of the present disclosure an outdoor unit 130 has been described, however, it should be appreciated that the outdoor unit 130 may be positioned indoors as well at a location wherein the user is not concerned about the potential for heat gain. Further, it is anticipated within the scope of the present disclosure that the air-cooled condenser may be a fluid-cooled condenser and more particularly a condenser that is cooled using ground source water.

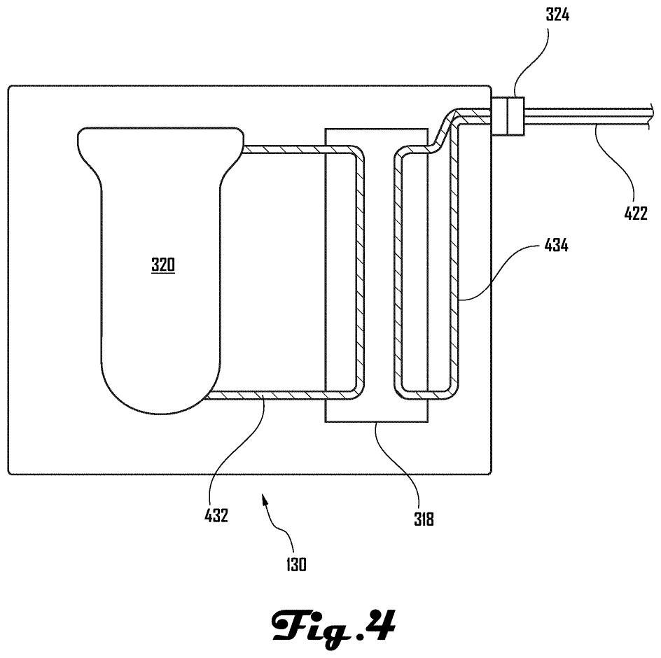

As illustrated in FIG. 4, the outdoor unit 130 can operate using a heat pump/air conditioning cycle to reduce the temperature of working fluid 432 or coolant, which in turn extracts heat from a circulating fluid 434 via the fluid-to-fluid heat exchanger 318. The cooled circulating fluid 434 is then circulated, via the circulation hose 322, between the exterior and interior units 130, 110. As was illustrated in FIG. 3a, the circulating fluid 434 may be directed through the fluid-to-air heat exchanger 312 in the interior unit 130 to cool the air directly.

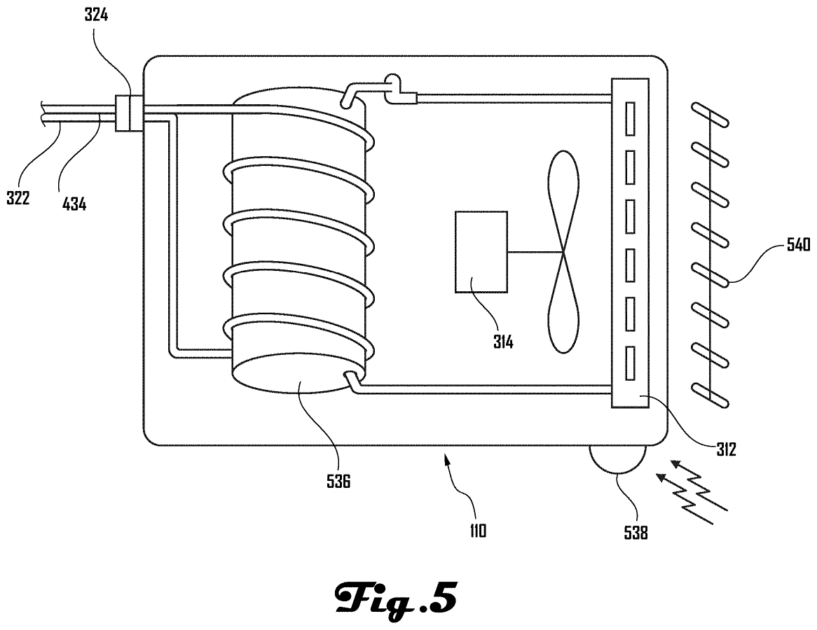

Further, as can be seen in FIG. 5, the circulating fluid 434 may be directed to reduce the overall temperature of a fluid storage tank 536 within the interior unit 110. In this embodiment, when cooling is needed in the indoor space, cold fluid from the cold fluid storage tank 536 is circulated through the fluid-to-air heat exchanger 312 where the fan 314 circulates room air across the heat exchanger 312 producing a cooling effect. One skilled in the art should appreciate that while the fluid storage tank 536 is shown in the interior unit 110 it could also be positioned within the exterior unit 130 or independently at an intermediate position along the circulation hose 322.

The example arrangement of FIG. 5 can allow a room cooling function and a fluid cooling function to be decoupled from one another in a temporal sense in that the control system may only operate the outdoor unit 130 when the temperature of the circulating fluid rises above a certain set point. Similarly, the indoor unit 110 can independently increase or decrease fan speed and fluid circulation rate in order to provide a great deal of control over the cooling effect as compared to the prior art on or off cooling systems. This decoupling of the indoor cooling loop and the outdoor cooling loop can further allow the outdoor unit 130 to cool the fluid when it is most efficient to do so. For example, the outdoor unit 130 may cool the fluid stored in the interior insulated cold fluid storage tank at night for cooling use during the day when the outdoor ambient temperatures increase.

In various embodiments, the circulating fluid can be a non-toxic, low freezing point coolant such as salt brine of water mixed with polyethylene glycol. This can be contrasted with some systems that circulate a refrigerant such as Freon or R-10 between the indoor and outdoor units 110, 130. The arrangement of various embodiments allows a user to selectively connect an indoor unit 110 with an outdoor unit 130 using a modular hose arrangement thereby eliminating a great deal of complexity and cost. Further, this arrangement can allow for freedom in placing the indoor unit 110 as needed for maximum cooling effect and occupant comfort. The circulation hose(s) 322 can be attached to the indoor and outdoor units 110, 130 using a quick release style coupler 342. Such quick release couplers 342 can include valving therein that prevents leakage of circulating fluid 434 when the circulation hose(s) 322 are disconnected.

To further enhance the modularity of the air conditioning unit 100, the indoor and/or outdoor units 110, 130 can be arranged such that they include multiple hose connection points so that multiple indoor units 110 can be connected to a single outdoor unit 130. Such connections may be parallel or made directly from each of the indoor units 110 to the outdoor unit 130. Alternately the indoor units 110 may be connected in series or in a daisy chain arrangement with the outdoor unit 130. Turning back to FIG. 5, the indoor unit 110 may include such functionality as heat sensors 538 and servo directed louvers 540 to direct cooling airflow to hotspots in a room (e.g., room occupants). Further, the indoor unit 110 may be configured to collect condensate and deposit the condensate back into the loop of circulating fluid 434. The outdoor unit 130 can then be configured to eject some fluid from the loop of circulating fluid 434 should the fluid capacity of the loop of circulating fluid 434 be exceeded by the addition of condensate.

It should be further appreciated by one skilled in the art that the arrangement of the various examples could operate equally well as a heating system. In operation, change that could be made is that the outdoor unit 130 would be run as a heat pump rather than as an air conditioner. In this manner, rather than cooling the circulating fluid, the outdoor unit 130 would heat the circulating fluid. Optionally, the indoor unit(s) 110 may instead include a supplemental heating arrangement such as an electrical heating coil.

It can therefore be seen that the present disclosure illustrates examples of a modular air conditioner unit 100 that can operate on the basic principle of a split system yet allows user serviceability and modular components such that the system is flexible. Further, various embodiments provide a modular air conditioning unit 100 that includes at least one indoor cooling unit 110 that has an integrated cold storage therein such that the temperature of the cold store is maintained by a circulating coolant fluid through user serviceable hose connections with an outdoor heat dissipation unit.

In various embodiments, the modular air conditioning unit 100 can comprise various suitable sensors and other additional hardware. For example, the indoor unit 110 and/or outdoor unit 130 can comprise a temperature sensor, humidity sensor, barometric pressure sensor, light sensor, and the like. It can be desirable for both the indoor and outdoor units to both have such sensors so that environmental conditions of both an indoor and outdoor environment can be determined.

Also, in various embodiments the modular air conditioning unit 100 can comprise a suitable computing device configured to perform one or more steps of at least one of the methods discussed herein, with such a computing system including elements such as a processor, memory, power source, sensor, communication unit, and the like. For example, a memory can store instructions, that when executed by the processor, cause performance of one or more steps of at least one of the methods discussed herein. In various embodiments, such a computing system can be complex or simple, with some embodiments operating via firmware instead of a processor executing instruction stored on a computer-readable medium. In further embodiments, a computing device can be absent, with functionalities achieved via physical components or under the control of an external device.

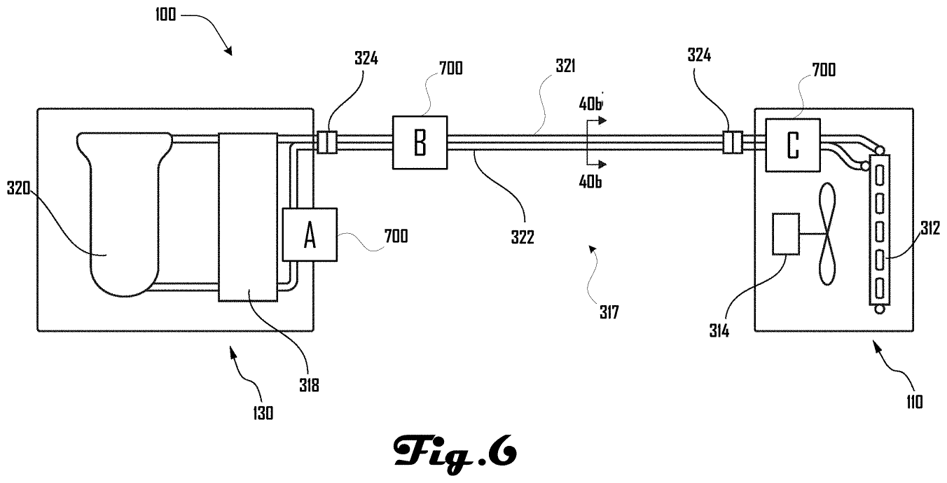

FIG. 6 illustrates an example embodiment of a modular climate control unit 100 with three example locations A, B, C of where a baffle strainer tank 700 can be located. For example, position A illustrates an example of a baffle strainer tank 700 positioned within the exterior unit 130 where a circulation hose either enters or exits the heat exchanger 318. Position B illustrates an example of a baffle strainer tank 700 positioned at either line 321 of the circulation hose 322 extending between the interior unit 110 and exterior unit 130. Position C illustrates an example of a baffle strainer tank 700 positioned within the exterior unit 130 where a circulation hose either enters or exits the heat exchanger 312. Being disposed along a portion of such a circulation hose can include respective ends of the circulation hose being coupled to a liquid intake 730 and liquid outlet 740 of the baffle strainer tank 700 such a that a flow of liquid of the circulation hose is caused to pass through the baffle strainer tank 700 as discussed in more detail herein.

While FIG. 6 illustrates three example positions of a baffle strainer tank 700, in various embodiments, the modular climate control unit 100 can comprise any suitable number of baffle strainer tanks 700 including 1, 2, 3, 4 or the like, which may or may not include one or more of the example locations A, B, C of FIG. 6. In a preferred embodiment, the modular climate control unit 100 has only one baffle strainer tank 700. In various embodiments such a baffle strainer tank 700 can be positioned fully or partially within a housing of the indoor and/or outdoor units 110, 130.

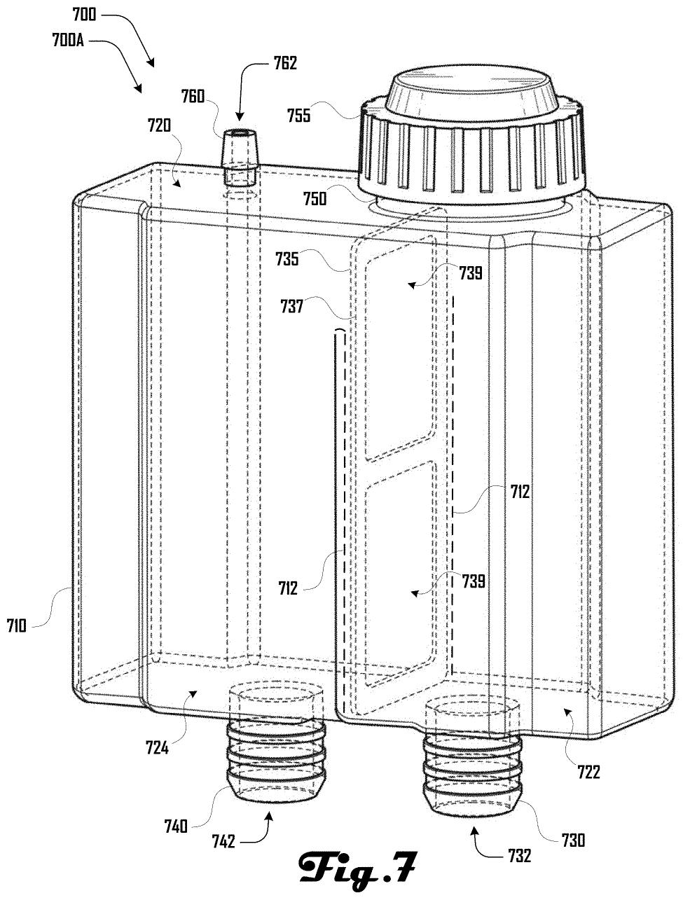

FIG. 7 illustrates one example embodiment 700A of a baffle strainer tank 700 that comprises a tank body 710 defining an internal tank cavity 720. A strainer plate 735 is disposed within the tank cavity 720 and held by a pair of opposing lips 712 defined by the tank body 710. The strainer plate 735 can comprise a strainer frame 737 that supports a strainer sheet 739 with the strainer frame 737 being held by the lips 712 of the tank body 710. The strainer plate 735 can separate the internal tank cavity 720 into a first cavity portion 722 and a second cavity portion 724.

The baffle strainer tank 700 can further comprise a liquid intake 730 that can define a liquid intake port 732, a liquid outlet 740 that defines a liquid outlet port 742 and a gas outlet 760 that defines a gas outlet port 762. The strainer plate 735 can be configured to allow fluid to flow through the strainer sheet 739 while straining out particulates in the fluid via the strainer sheet 739. For example, a flow of liquid comprising particulates can be introduced into the first cavity portion 722 of the internal tank cavity 720 via the liquid intake port 732 with the flow of liquid comprising particulates flowing through the strainer sheet 739 of the strainer plate 735, and into the second cavity portion 724 with at least a portion of the particulates being strained out of the liquid by the strainer sheet 739 of the strainer plate 735, with the strained particulates remaining in the first cavity portion 722. The strained liquid, with at least a portion of particulates removed, that flows into the second cavity portion 724 can flow out of the tank body 710 via the liquid outlet port 742.

In various examples, movement of fluid into the tank cavity 720, out of the tank cavity 720 and/or flowing through the strainer plate 735 can cause gas (e.g., air) dissolved or otherwise present in the fluid to come out of solution or otherwise present itself in the tank cavity 720 (e.g., due to turbulence, changes in pressure, changes in flow rate, changes in temperature, nucleation, and the like). In various embodiments, gas present within tank cavity 720 can be removed or otherwise allowed to leave the tank cavity 720 via the gas outlet port 762. Accordingly, in various embodiments, the gas outlet 760 can be positioned upward so that gas present within tank cavity 720 will rise through the liquid in the tank cavity 720 such that such gas can naturally accumulate at the top of the tank cavity 720 and exit via the gas outlet port 762. In some embodiments, a one-way valve can be associated with the gas outlet 760 such that gas can leave the tank cavity 720, but not enter the tank cavity 720. In some embodiments, a valve, filter, or other element can be associated with the gas outlet 760 such that gas can leave the tank cavity 720 without liquid leaving the tank cavity 720 via the gas outlet 760. In some embodiments, gas leaving the tank cavity 720 via the gas outlet 760 can vent into the internal or external units 110, 130 (e.g., within a housing of the internal or external units 110, 130), or can vent externally to the internal or external units 110, 130. For example, where the baffle strainer tank 700 is disposed along a liquid circulation hose within one of the internal or external units 110, 130, an air tube associated with the gas outlet 760 can run internally within the internal or external unit 110 and vent externally thereto. In another example, where the baffle strainer tank 700 is disposed along a line 321 of a circulation hose 322 extending between the interior unit 110 and exterior unit 130, the gas outlet 760 or associated element can vent below or within the top cover 170 into an internal location 260 or external location 270.

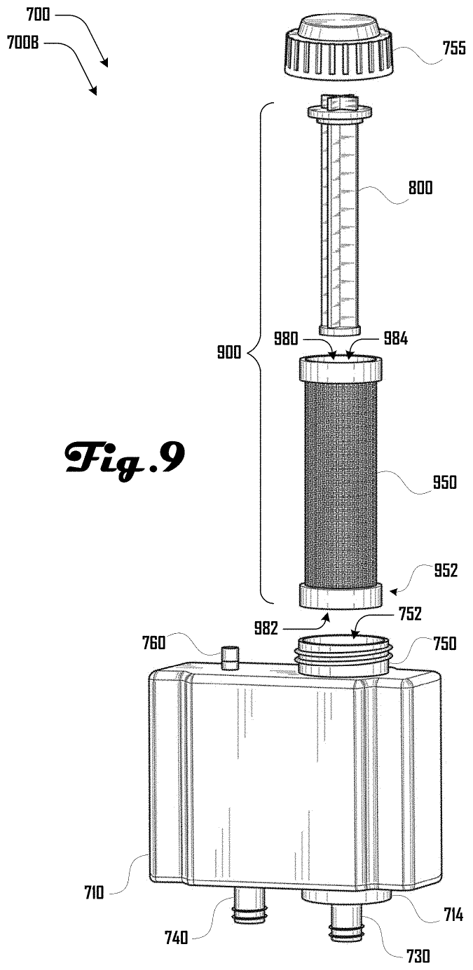

Additionally, the baffle strainer tank 700 can comprise a cap shaft 750 that defines a cap port 752 (See FIG. 9). A cap 755 can be coupled to the cap shaft 750 (e.g., via a screw connection) which can generate a gas- and/or fluid-tight seal about the cap shaft 750. In various embodiments, the cap port 752 can be sized to allow the strainer plate 735 to be inserted and removed from the tank cavity 720, which can be desirable for assembly of the baffle strainer tank 700, removal of the strainer plate 735 for replacement or cleaning, removal of strained particulates from tank cavity 720, removal of gas from the tank cavity 720, and the like. In some embodiments, cap port 752 can have a diameter of 34 mm. In further embodiments, the cap port 752 can have a diameter of 10 mm, 15 mm, 20 mm, 25 mm, 30 mm, 35 mm, 40 mm, 45 mm, 50 mm, 55 mm, 60 mm, 75 mm, 100 mm, and the like, or within a range between such values.

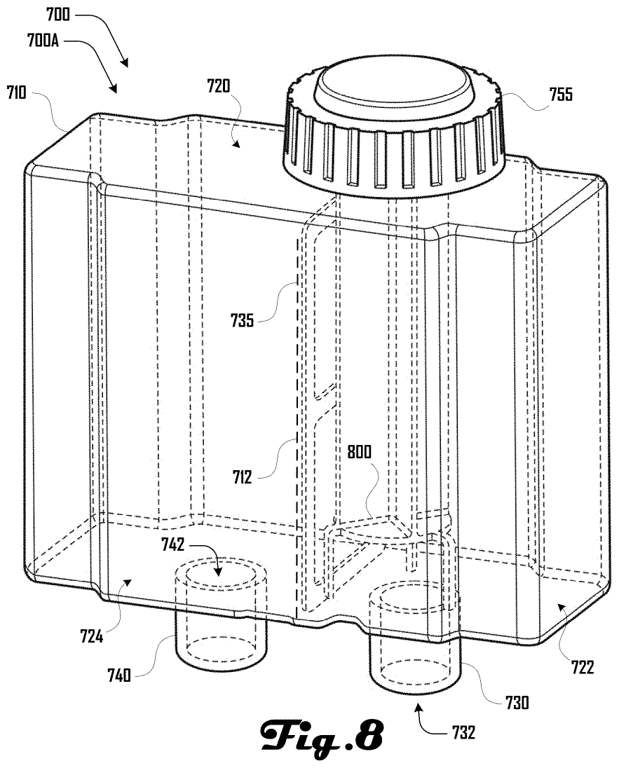

Turning to FIG. 8, in some embodiments, the baffle strainer tank 700 can comprise a baffle 800 that extends from the cap shaft 750 and/or cap 755 into the first cavity portion 722 of the tank cavity 720 and over at least a portion of the liquid intake port 732. In various embodiments, the baffle 800 can be configured to disrupt the flow of the liquid within the tank cavity 720 and cause formation or concentration of bubbles or otherwise cause gas to be released from the fluid within the tank cavity 720. The baffle 800 can be configured in various suitable ways as discussed in various examples herein.

Turning to FIG. 9, another embodiment 700B of a baffle strainer tank 700 is illustrated in a disassembled configuration that includes a baffle strainer assembly 900 comprising a baffle 800 configured to be disposed within a strainer tube 950, via a second opening 984 of the strainer tube 950. The nested strainer tube 950 and baffle 800 can be configured to be inserted within the tank cavity 720 via the cap port 752 with a bottom end 952 of the strainer tube 950 disposed within a coupling slot 714 defined by the tank body 710. The cap 755 can be screwed onto the cap shaft 750 so that the nested strainer tube 950 and baffle 800 are enclosed within the tank cavity 720.

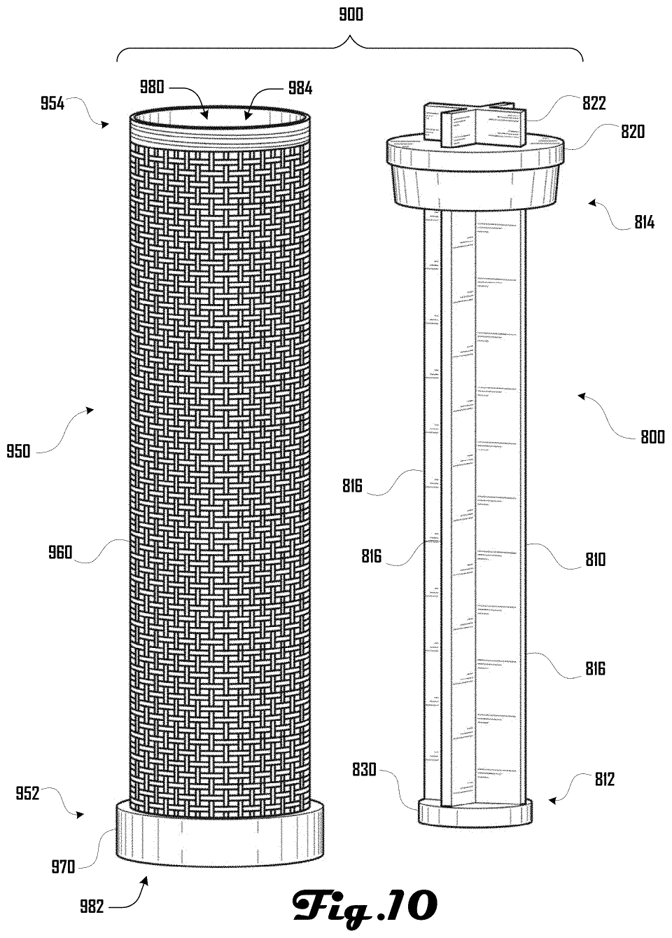

As shown in the example of FIG. 10, the strainer tube 950 can comprise a cylindrical strainer 960 that extends between a first and second end 952, 954 with a strainer cuff 970 disposed at one or both of the first and second ends 952, 954 (see e.g., FIGS. 9, 10, and 11). The strainer tube 950 can define a strainer cavity 980 including a first opening 982 and a second opening 984 at the first and second ends 952, 954 respectively. In various embodiments, the strainer tube 950 can have a consistent diameter along the length of the strainer tube 950 and the strainer tube 950 can be defined by a filter, mesh, or the like, having a 60-mesh pore size. In some embodiments, the strainer tube 950 can have a Mesh size of 35, 40, 45, 50, 60, 70, 80, 100, 120, 140, 170, 200, 230, 270, 325, 400, 450, 500, 635, or the like, or a range between such values. In some embodiments, the strainer tube 950 can have a pore, filter or straining size of 500, 400, 354, 297, 250, 210, 177, 149, 125, 105, 88, 74, 63, 53, 44, 37, 32, 25, 20 microns, or the like, or a range between such values. For example, such filter, mesh, or the like can be configured to not have a pore, filter or straining size greater than such values and can be configured to have a large portion of its surface area (e.g., 80%, 90%, 95%, 98%, or the like) with openings of such sizes. The strainer tube 950 can be made of various suitable materials including a metal mesh, a plastic, a fabric, a textile, or the like. The strainer sheet 739 and analogous elements can be configured similarly in various embodiments.

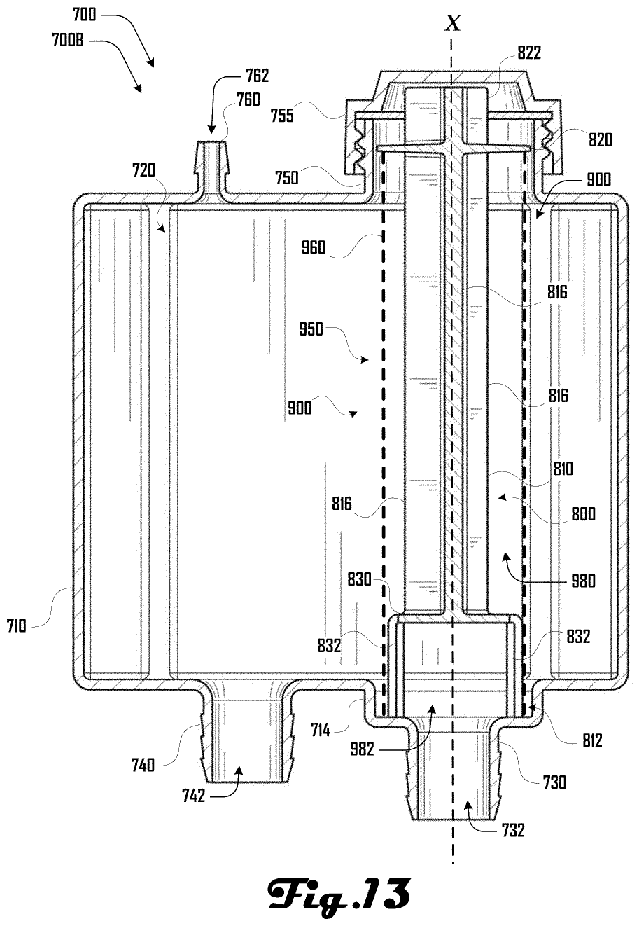

As shown in the example of FIG. 10, the baffle 800 can comprise an elongated baffle shaft 810 that extends from a first end 812 to a second end 814 with a baffle base 830 disposed at the first end 812 and baffle plug 820 disposed at the second end 814 of the baffle shaft 810. The baffle shaft 810 can be defined by a plurality of baffles 816, which can be rectangular members extending from a central axis X of the baffle 800 (see e.g., FIG. 13). In the example of FIG. 10, the baffle shaft 810 is defined by four rectangular baffles 816 of equal length that are disposed in a cross or X configuration with 90-degree angles between the baffles 816 and four planes of symmetry.

However, further embodiments can include any suitable number of baffles 816 (e.g., 1, 2, 3, 4, 5, 6, 7, 8, 9, 10, 12, 16, 20, 24, 32, 36, 48, 64, 100, 200, 500, 1000, or the like, or a range between such values). In further embodiments, such baffles can be any suitable shape and can be arranged in any suitable configuration, which may or may not have symmetry. Additionally, in some embodiments, the baffles 816 can have the same width, different widths, or the like. The baffle base 830 can comprise a planer cylindrical member at the first end 812 of the baffle shaft 810 or can have various other suitable configurations as discussed herein.

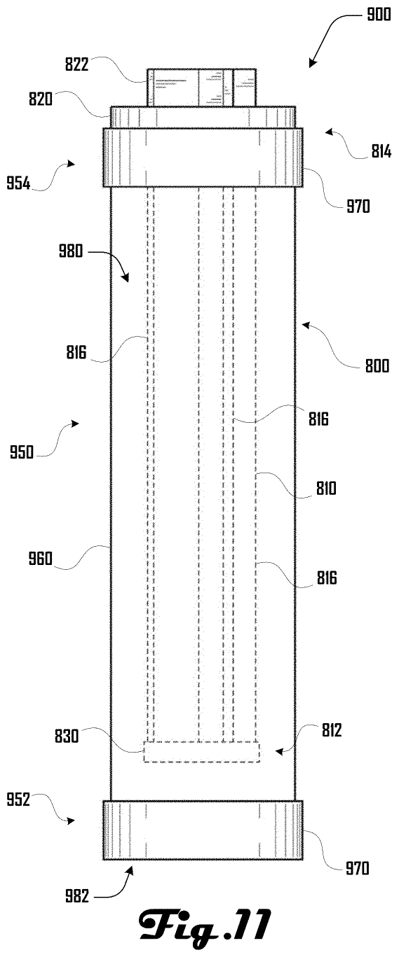

The baffle plug 820 can be configured to correspond to the diameter of the strainer cavity 980 such that the baffle shaft 810 can be inserted into the second opening 984 at the second end 954 of the strainer tube 950 until the baffle plug 820 is coupled at the second end 954 of the strainer tube 950 within the second opening 984 (e.g., via a strainer cuff 970 at the second end 954 as shown in the example of FIG. 11).

As further shown in the example of FIG. 11, the length of the baffle shaft 810 can be configured such that the first end 812 of the baffle 800 is disposed within the strainer cavity 980 set back from the first end 952 of the strainer tube 950 and set back from a strainer cuff 970 at the first end 952 of the strainer tube 950.

Additionally, in various embodiments, the baffle plug 820 can comprise a plug tip 822, which in some examples can be configured to engage with the cap 755 to prevent rotation of the baffle 800 within the tank cavity 720, which may otherwise be caused by the flow of fluid about the baffle 800 within the tank cavity 720.

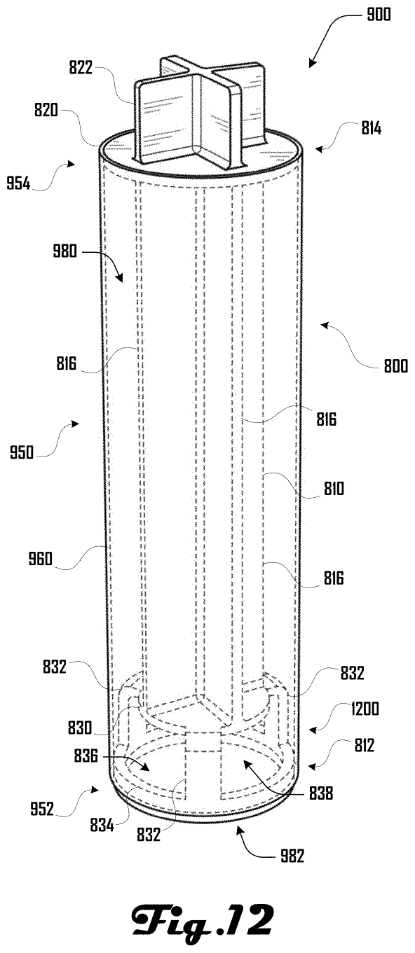

Turning to FIG. 12, another embodiment of a baffle is illustrated where the first end 812 of the baffle shaft 810 comprises a platform assembly 1200 that includes a plurality of legs 832 extending laterally and downward from a baffle base 830 to a base ring 834. The base ring 834 can define a base ring opening 836 that can open to the first opening 982 at the first end 952 of the strainer tube 950. The baffle base 830, legs 832 and base ring 834 can define a base cavity 838, which can be configured to allow liquid to flow into the strainer cavity 980 via the first opening 982 at the first end 952 of the strainer tube 950, around the baffle base 830, and toward the second end 814 of the baffle 800. As discussed herein, this flow of liquid can further flow through the cylindrical strainer 960 and into a tank cavity 720 of a baffle strainer tank 700, which can allow particulates in the flow of liquid to be strained by the strainer 960 and can allow gas in the flow of liquid to be expressed via interaction with the baffle 800 and/or strainer 960.

In various embodiments, the base ring 834 can have a greater diameter than the baffle base 830 and/or baffle shaft 810, which can be desirable for generating a flow passage around the baffle base 830. Additionally, in various embodiments, the outer rim of the base ring 834 can engage an internal face of the cylindrical strainer 960, which can be desirable for holding the baffle 800 in place within the strainer cavity 980 when exposed to forces of liquid flowing about and along the baffle 800, which may otherwise cause lateral or other movement of the baffle 800 within the strainer cavity 980 in some examples.

Additionally, while the example of FIG. 12 illustrates the platform assembly 1200 comprising three legs 832 and a cylindrical base ring 834, further embodiments can include any suitable number of legs 832 (e.g., 1, 2, 3, 4, 5, 10, 15, 20, or the like). Also, the base ring 834 can be absent in some embodiments or can have any other suitable configuration. Also, the base cavity 838 can be configured in various suitable ways including any suitable height defined by the baffle base 830 and first end 952 of the cylindrical strainer 960, bottom of the base ring 834, or the like.

Turning to FIG. 13, another example embodiment of a baffle strainer tank 700 is illustrated that includes a baffle strainer assembly 900 comprising a baffle 800 and strainer tube 950 with the bottom end 952 of the strainer tube 950 disposed within a coupling slot 714 defined by the tank body 710. In various embodiments, the coupling slot 714 can be a cylindrical depression in the tank body 710 with a diameter that corresponds to the bottom end 952 of the strainer tube 950, which allows the bottom end 952 of the strainer tube 950 to be fixed in place.

Additionally, as shown in the example of FIG. 13, at least a portion of the baffle strainer assembly 900 (e.g., the top end 954 of the strainer tube 950 and/or baffle plug 820) can be configured to reside within the cap shaft 750 with a diameter of the cap shaft 750 corresponding to a diameter of such a portion of the strainer assembly 900 such that the top end 954 of the baffle strainer assembly 900 is fixed in place within the cap shaft 750. In various embodiments, the cap shaft 750 and coupling slot 714 can be aligned relative to each other such that they share a common central axis X, where the baffle strainer assembly 900 can be centrally disposed coincident with this same central axis X as shown in the example of FIG. 13.

The strainer tube 950 can be configured to allow fluid to flow through the strainer 960 while straining out particulates in the fluid via the strainer 960. For example, a flow of liquid comprising particulates can be introduced into the strainer cavity 980 of the baffle strainer assembly 900 via the liquid intake port 732 with the flow of liquid comprising particulates flowing in and around the baffle 800 and through strainer 960, and into the tank cavity 720, with at least a portion of the particulates being strained out of the liquid by the strainer 960 of the baffle strainer assembly 900, with the strained particulates remaining in the strainer cavity 980. The strained liquid, with at least a portion of particulates removed, that flows into the tank cavity 720 can flow out of the tank body 710 via the liquid outlet port 742. In various embodiments, the liquid can be at a temperature of between −10° C. and 45° C., between −5° C. and 40° C., between 0° C. and 35° C., between 10° C. and 30° C., between 15° C. and 25° C., and the like.

In some embodiments, the fluid can flow in an a opposite direction with the intake 730 and outlet 740 being switched. For example, a flow of liquid comprising particulates can be introduced into the tank cavity 720 via an intake, through the strainer 960, and into the strainer cavity 980 of the baffle strainer assembly 900, with at least a portion of the particulates being strained out of the liquid by the strainer 960 of the baffle strainer assembly 900, with the strained particulates remaining in the tank cavity 720. The strained liquid, with at least a portion of particulates removed, that flows into the strainer cavity 980 can flow out the baffle strainer assembly 900 via an outlet port.

In various examples, movement of fluid about the baffle 800, into the strainer cavity 980, into the tank cavity 720, out of the tank cavity 720 and/or flowing through the strainer 960 can cause gas (e.g., air) dissolved or otherwise present in the fluid to come out of solution or otherwise express itself in the tank cavity 720 (e.g., due to turbulence, changes in pressure, changes in flow rate, changes in temperature, nucleation, and the like). In various embodiments, gas present within tank cavity 720 can be removed or otherwise allowed to leave the tank cavity 720 via the gas outlet port 762. Accordingly, in various embodiments, the gas outlet 760 can be positioned upward so that gas present within tank cavity 720 will rise through the liquid in the tank cavity 720 such that such gas can naturally accumulate at the top of the tank cavity 720 and exit via the gas outlet port 762.

In various embodiments, the cap port 752 can be sized to allow the baffle strainer assembly 900 or portions thereof to be inserted and removed from the tank cavity 720, which can be desirable for assembly of the baffle strainer tank 700, removal of the baffle strainer assembly 900 or portions thereof for replacement or cleaning, removal of strained particulates from tank cavity 720, removal of gas from the tank cavity 720, and the like. In some embodiments, the cap port 752, a maximum diameter of the baffle strainer assembly 900, or the like, can have a diameter of 34 mm. In further embodiments, such elements can have a diameter of 10 mm, 15 mm, 20 mm, 25 mm, 30 mm, 35 mm, 40 mm, 45 mm, 50 mm, 55 mm, 60 mm, 75 mm, 100 mm, and the like, or within a range between such values. In some embodiments, the baffle strainer assembly 900 can have a length of 136 mm. In some embodiments, the baffle strainer assembly 900 can have a length of 100 mm, 115 mm, 130 mm, 145 mm, 160 mm, 175 mm, 200 mm, 250 mm, 300 mm, 400 mm, 500 mm, 750 mm, and the like, or within a range between such values.

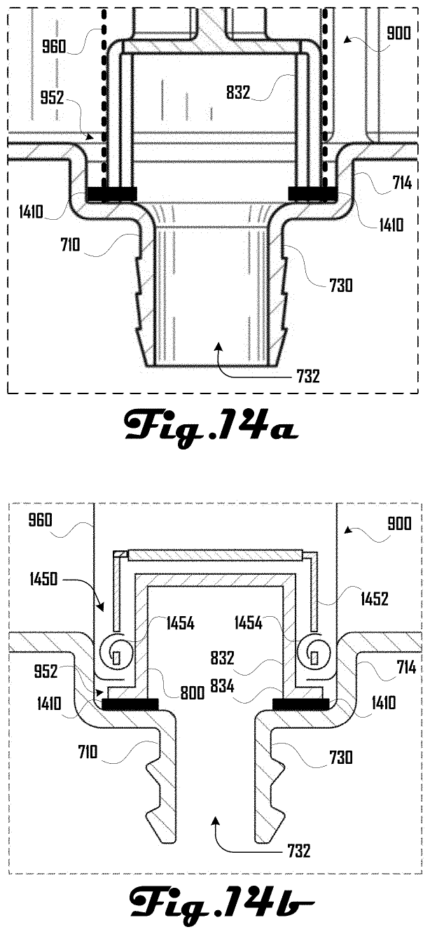

In various embodiments, a seal or other coupling between the baffle strainer assembly 900 and tank body 710 can be generated to prevent, or at least substantially prevent, liquid from passing around the first end 952 of the baffle strainer assembly 900 without being strained by the cylindrical strainer 960. For example, FIGS. 14a and 14b illustrate example embodiments where a gasket 1410 is disposed between the first end 952 of the baffle strainer assembly 900 and the tank body 710 within the coupling slot 714 proximate to the liquid intake 730. The gasket 1410 can comprise various suitable compliant material such as rubber, silicone, a plastic or the like. In various embodiments, the gasket 1410 can have a flat planar ring shape corresponding to the size of the liquid intake port 732 and/or liquid intake 730.

The first end 952 of the baffle strainer assembly 900 can be compressed against the gasket 1410 to generate a seal in various suitable ways, including via compression of the baffle strainer assembly 900 at the second end 954 when the cap 755 is screwed on over the second end 954 of the baffle strainer assembly 900. In some embodiments, such as FIG. 14b, a spring-plate assembly 1450 can be configured to apply a compressive force to generate a seal between the second end 954 of the baffle strainer assembly 900 and the tank body 710. For example, such a spring-plate assembly 1450 can comprise a spring plate 1452 and one or more springs 1454 as shown in the example of FIG. 14b.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, in some embodiments, elements that are specifically shown in some embodiments can be explicitly absent from further embodiments. Accordingly, the recitation of an element being present in one example should be construed to support some embodiments where such an element is explicitly absent.

What is claimed is:

1. An air conditioning unit comprising:
an interior unit disposed at a window within an indoor area of a building below a horizontal level of a sill of the window, the window separating the indoor area within the building and an exterior area external to the building, the interior unit comprising:
a fluid-to-air heat exchanger, and
a fan to circulate air across the fluid-to-air heat exchanger;
an exterior unit disposed at the window in the exterior area below the horizontal level of the sill, the exterior unit including:
a fluid-to-fluid heat exchanger, and
a system for supplying a working fluid that undergoes a pressure drop to cool the working fluid, the working fluid within a first circulation loop, the cooled working fluid being directed to a first side of the fluid-to-fluid heat exchanger;
a circulation hose that extends through the window and over the sill to connect the exterior unit and the interior unit, the circulation hose connected between a fluid side of the fluid-to-air heat exchanger and a second side of the fluid-to-fluid heat exchanger, the circulation hose allowing a circulating fluid, that is maintained separate and apart from the working fluid, within a second circulation loop, to transport heat between the interior unit and the exterior unit such that the cooling of the working fluid and the cooling of the circulating fluid are temporally decoupled from one another; and
a baffle strainer tank disposed along a first circulation hose portion within a housing of the exterior unit, disposed along a second circulation hose portion within a housing of the interior unit or disposed along a third circulation hose portion extending between the exterior unit and the interior unit, the baffle strainer tank comprising:
a tank body defining a tank cavity,
a liquid intake that defines a liquid intake port,
a liquid outlet that defines a liquid outlet port,
a gas outlet that defines a gas outlet port,
a cap shaft that defines a cap port, with a cap coupled to the cap shaft via a screw connection, the cap port aligned with the liquid intake port along a central axis X;
a baffle strainer assembly that includes:
a baffle that comprises an elongated baffle shaft that extends from a first baffle end to a second baffle end along the central axis X, with a baffle base disposed at the first baffle end and baffle plug disposed at the second baffle end of the elongated baffle shaft, the elongated baffle shaft defined by a plurality of baffles that are rectangular members extending radially from the central axis X of the baffle; and
a strainer tube comprising a cylindrical strainer that extends between a first strainer end and a second strainer end with a consistent diameter parallel to the central axis X, with a strainer cuff disposed at one or both of the first and second strainer ends, the strainer tube defining a strainer cavity including a first strainer opening and a second strainer opening at the first and second strainer ends respectively,
wherein the baffle is disposed within the strainer tube with the elongated baffle shaft extending within the strainer cavity, the baffle plug coupled to the second strainer end of the strainer tube within and plugging the second strainer opening,
wherein the baffle strainer tank is configured to allow a flow of liquid through the cylindrical strainer while straining out particulates in the liquid via the cylindrical strainer by:
the flow of the liquid comprising particulates being introduced into the strainer cavity of the baffle strainer assembly via the liquid intake port, with the flow of the liquid comprising particulates flowing in and around the baffle and through the cylindrical strainer and into the tank cavity, with at least a portion of the particulates being strained out of the flow of the liquid by the cylindrical strainer of the baffle strainer assembly, with the strained particulates remaining in the strainer cavity, and
the strained flow of the liquid, with at least a portion of the particulates removed, that flows into the tank cavity, then flowing out of the tank body via the liquid outlet port,
wherein the baffle strainer tank is configured to cause gas present within the flow of the liquid to be expressed in the strainer cavity of the baffle strainer assembly based at least on contact of the flow of the liquid with the baffle, and
wherein the expressed gas leaves the tank cavity via the gas outlet port.

2. The air conditioning unit of claim 1, wherein the cylindrical strainer is defined by a filter or mesh having a pore size of no larger than between 50-mesh to 70-mesh for straining out the particulates in the liquid via the cylindrical strainer.

3. The air conditioning unit of claim 1, wherein the elongated baffle shaft is defined by four rectangular baffles of equal width that are disposed in a cross or X configuration with 90-degree angles between the four rectangular baffles and having four planes of symmetry.

4. The air conditioning unit of claim 1, wherein the first baffle end of the elongated baffle shaft comprises a platform assembly that includes:
a plurality of legs extending laterally and downward from the baffle base to a base ring, the base ring defining a base ring opening that opens to the first strainer opening at the first strainer end of the strainer tube, the baffle base, legs and base ring defining a base cavity configured for the flow of liquid to flow into the strainer cavity via the first strainer opening at the first strainer end of the strainer tube, around the baffle base, and toward the second baffle end of the baffle.

5. The air conditioning unit of claim 1,
wherein the cap port and the baffle strainer assembly have a diameter of no greater than between 30 mm and 40 mm, and
wherein the baffle strainer assembly has a length of between 130 mm and 145 mm.

6. An air conditioning unit comprising:
a baffle strainer tank comprising:
a tank body defining a tank cavity,
a liquid intake that defines a liquid intake port,
a liquid outlet that defines a liquid outlet port,
a gas outlet that defines a gas outlet port,
a cap shaft that defines a cap port, with a cap coupled to the cap shaft via a screw connection, the cap port aligned with the liquid intake port along a central axis X;
a baffle strainer assembly that includes:
a baffle that comprises an elongated baffle shaft that extends from a first baffle end to a second baffle end along the central axis X, with a baffle base disposed at the first baffle end and baffle plug disposed at the second baffle end of the elongated baffle shaft, the elongated baffle shaft defined by a plurality of baffles that are rectangular members extending radially from the central axis X of the baffle; and
a strainer tube comprising a cylindrical strainer that extends between a first strainer end and a second strainer end with a consistent diameter parallel to the central axis X, with a strainer cuff disposed at one or both of the first and second strainer ends, the strainer tube defining a strainer cavity including a first strainer opening and a second strainer opening at the first and second strainer ends respectively,
wherein the baffle is disposed within the strainer tube with the elongated baffle shaft extending within the strainer cavity, the baffle plug coupled to the second strainer end of the strainer tube within and plugging the second strainer opening,
wherein the baffle strainer tank is configured to allow a flow of liquid through the cylindrical strainer while straining out particulates in the liquid via the cylindrical strainer by:
the flow of the liquid comprising particulates being introduced into the strainer cavity of the baffle strainer assembly via the liquid intake port, with the flow of the liquid comprising particulates flowing in and around the baffle and through the cylindrical strainer and into the tank cavity, with at least a portion of the particulates being strained out of the flow of the liquid by the cylindrical strainer of the baffle strainer assembly, with the strained particulates remaining in the strainer cavity, and
the strained flow of the liquid, with at least a portion of the particulates removed, that flows into the tank cavity, then flowing out of the tank body via the liquid outlet port,
wherein the baffle strainer tank is configured to cause gas present within the flow of the liquid to be expressed in the strainer cavity of the baffle strainer assembly based at least on contact of the flow of the liquid with the baffle, and
wherein the expressed gas leaves the tank cavity via the gas outlet port.

7. The air conditioning unit of claim 6, wherein the cylindrical strainer is defined by a filter or mesh having a pore size of no larger than between 50-mesh to 70-mesh for straining out the particulates in the liquid via the cylindrical strainer.

8. The air conditioning unit of claim 6, wherein the elongated baffle shaft is defined by four rectangular baffles of equal width that are disposed in a cross or X configuration with 90-degree angles between the four rectangular baffles and having four planes of symmetry.

9. The air conditioning unit of claim 6, wherein the first baffle end of the elongated baffle shaft comprises a platform assembly that includes:
a plurality of legs extending laterally and downward from the baffle base to a base ring, the base ring defining a base ring opening that opens to the first strainer opening at the first strainer end of the strainer tube, the baffle base, legs and base ring defining a base cavity configured for the flow of liquid to flow into the strainer cavity via the first strainer opening at the first strainer end of the strainer tube, around the baffle base, and toward the second baffle end of the baffle.

10. The air conditioning unit of claim 6,
wherein the cap port and the baffle strainer assembly have a diameter of no greater than between 30 mm and 40 mm, and
wherein the baffle strainer assembly has a length of between 130 mm and 145 mm.

11. An air conditioning unit comprising:
a baffle strainer tank that includes:
a tank body defining a tank cavity,
a liquid intake that defines a liquid intake port,
a liquid outlet that defines a liquid outlet port, and
a baffle strainer assembly.

12. The air conditioning unit of claim 11, wherein the baffle strainer assembly comprises a baffle that includes:
an elongated baffle shaft that extends from a first baffle end to a second baffle end along a central axis X and defined by a plurality of baffles extending radially from the central axis X of the baffle,
a baffle base disposed at the first baffle end, and
baffle plug disposed at the second baffle end of the elongated baffle shaft.

13. The air conditioning unit of claim 11, wherein the baffle strainer assembly comprises a strainer tube comprising a strainer that extends between a first strainer end and a second strainer end, the strainer tube defining a strainer cavity including a first strainer opening and at the first strainer end.

14. The air conditioning unit of claim 13, wherein a baffle is disposed within the strainer tube with an elongated baffle shaft extending within the strainer cavity, and a baffle plug coupled to the second strainer end of the strainer tube.

15. The air conditioning unit of claim 11, wherein the baffle strainer tank is configured to allow a flow of liquid through a strainer of the baffle strainer assembly while straining out particulates in the liquid via the strainer.

16. The air conditioning unit of claim 15, wherein straining out the particulates in the liquid via the strainer comprises:
the flow of the liquid comprising the particulates being introduced into a strainer cavity of the baffle strainer assembly via the liquid intake port, with the flow of the liquid comprising the particulates flowing in the strainer cavity and through the strainer and into the tank cavity, with at least a portion of the particulates being strained out of the flow of the liquid by the strainer of the baffle strainer assembly with the strained particulates remaining in the strainer cavity.

17. The air conditioning unit of claim 11, wherein the baffle strainer tank is configured to cause gas present within a liquid to be expressed in a strainer cavity of the baffle strainer assembly based at least on contact of the liquid with a baffle of the baffle strainer assembly.

18. The air conditioning unit of claim 11, wherein the baffle strainer tank comprises a cap shaft that defines a cap port, the cap port aligned with the liquid intake port along a central axis X.

19. The air conditioning unit of claim 11, wherein the baffle strainer tank comprises a cap shaft that defines a cap port, the cap port and the baffle strainer assembly having a diameter of no greater than between 30 mm and 40 mm, with the baffle strainer assembly configured to be inserted into the tank cavity via the cap port.

20. The air conditioning unit of claim 11, wherein the baffle strainer tank further comprises a gas outlet that defines a gas outlet port, wherein gas expressed from a liquid within the baffle strainer assembly, based at least in part on contact with a baffle of the baffle strainer assembly, leaves the tank cavity via the gas outlet port.
